(19) United States
(12) Patent Application Publication
(10) Pub. No.: US 2006/0274377 A1
(43) Pub. Date: Dec. 7, 2006

(54) Image alignment method and image forming apparatus employing the same

(75) Inventor: Young-Sun Chun, Yongin-si (JP)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/440,123

(22) Filed: May 25, 2006

(30) Foreign Application Priority Data
Jun. 4, 2005 (KR) 2005-48113

(51) Int. Cl. G06K 15/00; G06K 15/10

(52) U.S. Cl. 358/3.26; 358/1.5; 358/1.18

(57) ABSTRACT

An image alignment method and an image forming apparatus employing the same are provided. The apparatus includes a test mark detector for detecting first and second test marks printed on a printing medium, an encoder output pulse generator for generating encoder output pulses, an absolute position determiner for determining absolute positions by counting the encoder output pulses output from the encoder output pulse generator, and an actual distance calculator for receiving first and second position values output from the absolute position determiner when the first and second test marks are detected and for calculating an actual distance between the first and second test marks using the first and second position values.

### CROSS-REFERENCE TO RELATED PATENT APPLICATION

This application claims the benefit under 35 U.S.C. §119(a) of Korean Patent Application No. 10-2005-0048113, filed on Jun. 4, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an image alignment method for performing image alignment using first and second position values obtained by an analog encoder when first and second test marks are detected, and an image forming apparatus employing the same.

2. Description of the Related Art

An image forming apparatus, such as an ink-jet printer or an ink-jet multi-function product (MFP), includes a single print head or a plurality of print heads installed in a carriage moving left and right or up and down over a sheet of paper. An image is printed for a line by ejecting ink from the print head while the carriage moves in a single direction or back and forth. An entire image preferred by a user is obtained by combining images printed for each line. The print quality of the entire image may decrease for various reasons. For example, an image alignment error may cause the print quality to decrease. The image alignment error may be generated due to curvature of a print head, different ejection patterns of nozzles, different positions of print heads of an ink cartridge, or a difference in speeds of print head. The image alignment error may also be generated due to variations in the periods between when ink drops according to a variation in the speed of and a moving direction of the cartridge.

In the prior art, a user is able to compensate for the image alignment error by printing a plurality of test marks and checking the alignment of the test marks in advance. According to the prior art, a plurality of test marks are printed to compensate for the image alignment error. The test marks are divided into test mark patterns for checking horizontal alignment and for checking vertical alignment. Usually, a plurality of test marks are printed to check the horizontal or vertical alignment. The user selects a test mark with the best alignment out of the printed test marks. The ink-jet image forming apparatus then performs the compensation by selecting a printing start position, an ink ejection speed, and ink nozzles most suitable for image printing according to the test mark selected by the user.

However, the image alignment method described above is inconvenient since the user must directly check a plurality of test marks printed on a sheet one by one. This results in a longer time required for the image alignment and causes the user to experience visual fatigue. Also, since the image alignment method relies on the sense of sight of the user, the possibility of selecting an incorrect test mark cannot be excluded. Therefore, it is difficult to guarantee accuracy of the image alignment. Recently, image forming apparatuses have been used to compensate for certain disadvantages. However, error detection remains complicated even though theses systems are capable of automatically measuring an error between test marks.

Accordingly, there is a need for an improved system and method for providing an image alignment method and an image forming apparatus for performing image alignment.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an image alignment method and an image forming apparatus for performing image alignment using first and second position values obtained by an analog encoder when first and second test marks are detected.

According to an aspect of an exemplary embodiment of the present invention, an image forming apparatus having an image alignment function is provided. A test mark detector detects first and second test marks printed on a printing medium, an encoder output pulse generator generates encoder output pulses, and an absolute position determiner determines absolute positions by counting the encoder output pulses output from the encoder output pulse generator. Also, an actual distance calculator receives first and second position values output from the absolute position determiner when the first and second test marks are detected and calculates an actual distance between the first and second test marks using the first and second position values.

According to another aspect of an exemplary embodiment of the present invention, an image alignment method is provided. First and second test marks separated by a designed distance are printed on a printing medium. The printed first and second test marks are detected from the printing medium, first and second position values are obtained when the first and second test marks are detected, and an actual distance between the printed first and second test marks is calculated using the first and second position values.

According to another aspect of an exemplary embodiment of the present invention, a computer readable recording medium is provided with a computer readable program for performing the image alignment method recorded thereon.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings in which:

FIG. 1 is a block diagram of an image forming apparatus having an image alignment function, according to an exemplary embodiment of the present invention;

FIG. 2 is a detailed block diagram of an encoder output pulse generator of FIG. 1;

FIG. 3 is a detailed block diagram of a spatial interpolator of FIG. 2, according to an exemplary embodiment of the present invention;

FIG. 4 is a detailed block diagram of a spatial interpolator of FIG. 2, according to another exemplary embodiment of the present invention;

FIG. 5 is a waveform diagram illustrating a process of generating quadrature signals in a spatial interpolator of FIG. 2;

FIGS. 6A through 6F illustrate test marks used in a process of determining an image alignment error and related signal waveforms; and

FIG. 7 is a flowchart of an image alignment method in an ink-jet image forming apparatus, according to an exemplary embodiment of the present invention.

Throughout the drawings, the same drawings reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

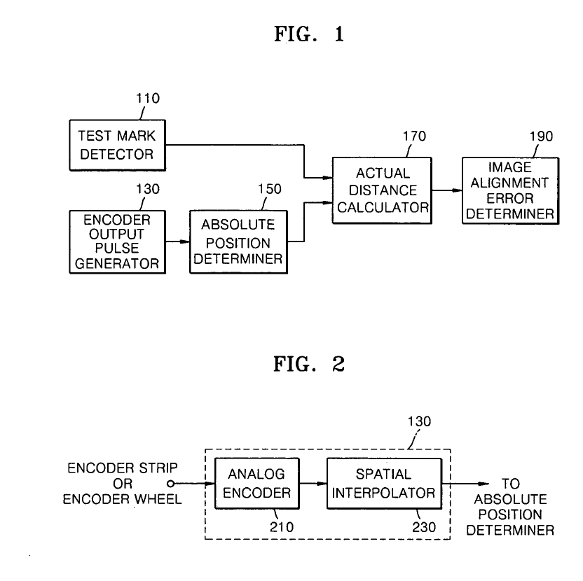

FIG. 1 is a block diagram of an image forming apparatus having image an image alignment function, according to an exemplary embodiment of the present invention. Referring to FIG. 1, the image forming apparatus includes a test mark detector 110, an encoder output pulse generator 130, an absolute position determiner 150, an actual distance calculator 170, and an image alignment error determiner 190.

First and second test marks separated from each other by a designated distance are printed on a printing medium when a signal requesting image alignment error compensation is received from an operational panel (not shown) of the image forming apparatus or a host computer (not shown) connected to the image forming apparatus. The test mark detector 110 then outputs first and second detection signals by detecting the first and second test marks printed on the printing medium. The test mark detector 110 can be implemented by a typical optical sensor or by adding an image sensor to an optical sensor to further improve accuracy of the test mark detection.

The encoder output pulse generator 130 senses an encoder wheel (not shown) or an encoder strip (not shown) and generates encoder output pulses in response to the sensed encoder wheel or strip.

The absolute position determiner 150 determines an absolute position by counting the encoder output pulses output from the encoder output pulse generator 130 and outputs position values.

The actual distance calculator 170 receives first and second position values output from the absolute position determiner 150 when the first and second detection signals are output from the test mark detector 110 and calculates an actual distance between the first and second test marks using the first and second position values. For example, the actual distance between the first and second test marks can be calculated using a value obtained by subtracting the first position value from the second position value.

In another exemplary embodiment of the present invention, the image forming apparatus may further include an image alignment error determiner 190. The image alignment error determiner 190 stores a designed distance between the first and second test marks in advance, obtains a difference between the designed distance and the actual distance calculated by the actual distance calculator 170, and determines the obtained difference as an image alignment error.

FIG. 2 is a detailed block diagram of the encoder output pulse generator 130 of FIG. 1. Referring to FIG. 2, the encoder output pulse generator 130 includes an analog encoder 210 and a spatial interpolator 230.

When the encoder strip or encoder wheel is connected to the analog encoder 210, the analog encoder 210 generates an analog encoder signal in response to a sensing signal obtained by detecting the encoder strip or encoder wheel. Since an analog encoder with a reduced cost or reduced class has a low physical resolution, its resolution can be improved by using the spatial interpolator 230.

The spatial interpolator 230 samples the analog encoder signal generated by the analog encoder 210 by dividing one period of the analog encoder signal into predetermined sections, obtains positional change state information (PCSI) by comparing a recent state containing fine position information in one period to a current output of the analog encoder 210, and predicts a current estimation state reflecting a current position of the analog encoder 210 from the PCSI. The spatial interpolator 230 also generates encoder output pulses, which are quadrature signals for controlling a motor, and outputs the encoder output pulses to the absolute position determiner 150. The number of sections into which one period of the analog encoder signal is divided can be variously set according to a required resolution when the image forming apparatus is designed. For example, when one period of the analog encoder signal is divided into 8 sections, the resolution of the analog encoder 210 is two times the resolution of a digital encoder corresponding to the analog encoder 210. When one period of the analog encoder signal is divided into 16 sections, the resolution of the analog encoder 210 is four times the resolution of the corresponding digital encoder. When the number of sections is N (N is a positive integer), a resolution of N/4 times the resolution of the digital encoder corresponding to the analog encoder 210 can be obtained.

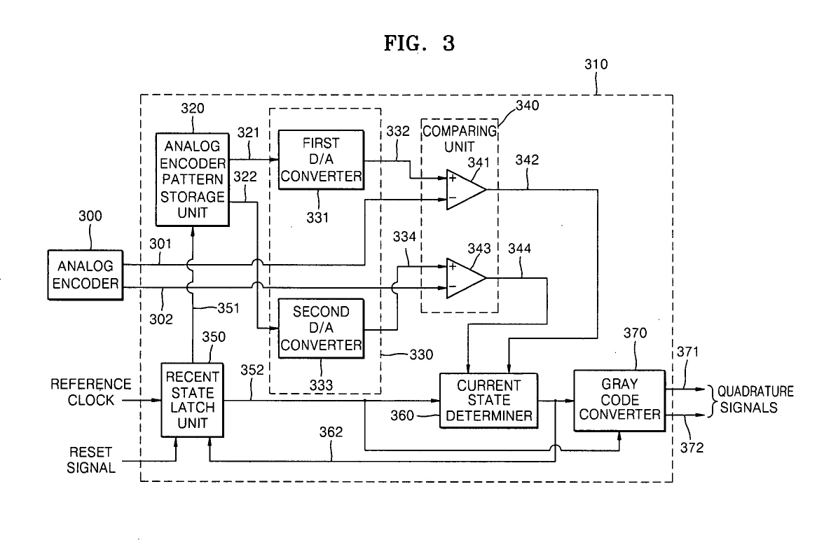

FIG. 3 is a detailed block diagram of the spatial interpolator 230 (310) of FIG. 2, according to an exemplary embodiment of the present invention. Referring to FIG. 3, the spatial interpolator 310 includes an analog encoder pattern storage unit 320, a digital/analog (D/A) converting unit 330, a comparing unit 340, a recent state latch unit 350, a current state determiner 360, and a gray code converter 370. The D/A converting unit 330 includes a first D/A converter 331 and a second D/A converter 333 and the comparing unit 340 includes a first comparator 341 and a second comparator 343.

The analog encoder pattern storage unit 320 stores values obtained by sampling and quantizing a first analog encoder signal 301 and a second analog encoder signal 302, which are signals generated by an analog encoder 300 when the image forming apparatus is initialized, for every section into which the first analog encoder signal 301 and the second analog encoder signal 302 are divided. When the analog encoder pattern storage unit 320 receives a recent state 351 from the recent state latch unit 350, the analog encoder pattern storage unit 320 outputs a first digital pattern value 321 and a second digital pattern value 322 to the D/A converting unit 330 in synchronization with the recent state 351. The first analog encoder signal 301 and the second analog encoder signal 302 are pseudo sine wave signals with a 90° phase difference between them.

In an exemplary embodiment of the present invention, since one period of the first or second analog encoder signal 301 or 302 is divided into 8 sections (0 to 7) as illustrated in FIG. 5. Therefore, the analog encoder pattern storage unit 320 stores 8 sampling values for each of the first analog encoder signal 301 and the second analog encoder signal 302. Although a sine wave is illustrated in FIG. 5, an actual output of the analog encoder 300 can be different from the sine wave illustrated in FIG. 5. For convenience, the actual output of the analog encoder 300 is assumed to be a sine wave.

The D/A converting unit 330 converts the first digital pattern value 321 and the second digital pattern value 322 read from the analog encoder pattern storage unit 320 into first and second analog pattern values 332 and 334 and outputs the first and second analog pattern values 332 and 334 to the comparing unit 340. In the D/A converting unit 330, the first D/A converter 331 reads the first digital pattern value 321 stored in the analog encoder pattern storage unit 320 and converts the read first digital pattern value 321 into the first analog pattern value 332. The second D/A converter 333 reads the second digital pattern value 322 stored in the analog encoder pattern storage unit 320 and converts the read second digital pattern value 322 into the second analog pattern value 334.

The comparing unit 340 receives the first and second analog pattern values 332 and 334 and the first and second analog encoder signals 301 and 302, compares their relative amplitudes, and outputs PCSI 342 and 344, which are digital signals X_up and Y_up with a value of 0 or 1. In more detail, the first comparator 341 outputs a result obtained by comparing the first analog pattern value 332 output from the first D/A converter 331 to the first analog encoder signal 301 output from the analog encoder 300, and the PCSI 342 of the first analog encoder signal 301 is X_up. The second comparator 343 outputs a result obtained by comparing the second analog pattern value 334 output from the second D/A converter 333 to the second analog encoder signal 302 output from the analog encoder 300, and the PCSI 344 of the second analog encoder signal 302 is Y_up. The digital signals X_up and Y_up are PCSI and used to predict a subsequent state, such as, a current estimation state, together with recent state information.

The recent state latch unit 350 receives a current estimation state 362, which is an output signal of the current state determiner 360, and simultaneously latches the current estimation state 362 and outputs the current estimation state 362 to the current state determiner 360 as a recent state 352 to determine a subsequent state. Also, the recent state latch unit 350 outputs the previous state 352 provided to the current state determiner 360 to the analog encoder pattern storage unit 320. When the image forming apparatus is initialized, the state of the recent state latch unit 350 is reset and initialized according to a reset signal.

The current state determiner 360 determines the current estimation state, which is a state of a subsequent position, by using the PCSI (X_up and Y_up) 342 and 344 received from the comparing unit 340 and the recent state 352 received from the recent state latch unit 350. The operation of the current state determiner 360 will be described in detail with reference to FIG. 5.

The gray code converter 370, which acts as a driving signal generator, converts the state information 362 received from the current state determiner 360 or the recent state latch unit 350 to a gray code and generates quadrature signals dX and dY 371 and 372 using the converted gray code. To do this, the gray code converter 370 can pre-set a correspondence between the gray code and the quadrature signals dX and dY 371 and 372 and stores the correspondence as a look-up table. Table 1 illustrates an example of the look-up table. Instead of the gray code converter 370, the current state determiner 360 may store a state information code containing information regarding the quadrature signals dX and dY 317 and 372 and generate the quadrature signals dX and dY 371 and 372 using the state information code. The quadrature signals dX and dY 371 and 372 are used as driving signals for the motor because the quadrature signals dX and dY 371 and 372 can induce the maximum torque. The quadrature signals dX and dY 371 and 372 generated by the gray code converter 370 are output to the absolute position determiner 150.

Table 1 illustrates an example of state information, state information codes, and corresponding quadrature signals. The quadrature signals corresponding to the gray code can be modified if necessary.

TABLE 1

| State | | State | |
|---|---|---|---|
| information using | | information | Quadrature signals |
| decimal numbers | BCD code | code | (520 and 521 of FIG. 5) |
| 0 | 000 | 010 | 10 |
| 1 | 001 | 011 | 11 |
| 2 | 010 | 001 | 01 |
| 3 | 011 | 000 | 00 |
| 4 | 100 | 110 | 10 |
| 5 | 101 | 111 | 11 |
| 6 | 110 | 101 | 01 |
| 7 | 111 | 100 | 00 |

In an exemplary embodiment of the present invention the image forming apparatus is barely affected by disturbance and the accuracy of the encoder is improved. This occurs since quadrature signals used to control the rotation of a motor are generated by feeding back pseudo sine wave output signals produced by the analog encoder 300. The spatial interpolator 310 illustrated in FIG. 3 may also include an analog encoder pattern generator (not shown) for generating analog encoder patterns by feeding back and sampling the first and second analog encoder signals 301 and 302 output from the analog encoder 300 when the image forming apparatus is initialized. If the analog encoder pattern generator is also included, the generated analog encoder patterns are stored in the analog encoder pattern storage unit 320.

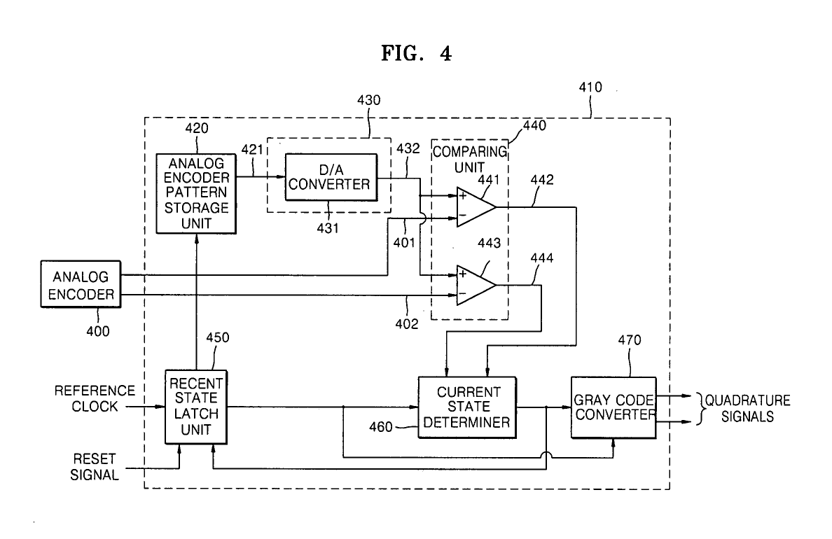

FIG. 4 is a detailed block diagram of the spatial interpolator 230 (410) of FIG. 2, according to another exemplary embodiment of the present invention. Referring to FIG. 4, the spatial interpolator 410 includes an analog encoder pattern storage unit 420, a D/A converting unit 430, a comparing unit 440, a recent state latch unit 450, a current state determiner 460, and a gray code converter 470.

Unlike the D/A converting unit 330, the D/A converting unit 430 includes only one D/A converter 431. The analog encoder pattern storage unit 420 can store channel data represented by an analog encoder signal which is more sensitive to a positional change, such as, channel data with higher sensitivity, for each section (state) into which the period of the analog encoder signal is divided. The analog encoder pattern storage unit 420 can also store valid channel information indicating the kind of channel for each section together with the channel data. More specifically, the number of D/A converters can be reduced to one by using the valid channel information and a multiplexer. Thus, a structure which requires less space, is robust against noise, and which has only one D/A converter compared to the exemplary embodiment of the present invention shown in FIG. 3 is possible. The D/A converter 431 converts an analog encoder signal 421 output by the analog encoder pattern storage unit 420 into a converted analog signal 432 and outputs the converted analog signal 432 to the comparing unit 440. Here, the D/A converter 431 converts the analog encoder signal 421 output from the analog encoder pattern storage unit 420 into the converted analog signal 432. The converted analog signal 432 is output to a first comparator 441 and a second comparator 443.

The comparing unit 440 receives the converted analog signal 432 output from the D/A converting unit 430 and first and second analog encoder signals 401 and 402 output from an analog encoder 400, compares their relative amplitudes, and outputs PCSI X_up and Y_up 442 and 444, which are digital signals with a value of 0 or 1.

Unlike the exemplary embodiment of the present invention illustrated in FIG. 3, the exemplary embodiment of the present invention illustrated in FIG. 4 only needs one D/A converter which facilitates the reduction of manufacturing costs and power consumption.

The configurations and operations of the analog encoder pattern storage unit 420, the comparing unit 440, the recent state latch unit 450, the current state determiner 460, and the gray code converter 470 are analogous to those of corresponding components of the exemplary embodiment of the present invention illustrated in FIG. 3.

The gray code converter 470 generates a driving signal for a motor. Since a new code is generated by continuously changing one bit in the gray code, the number of error is low when the gray code is used as an input code. Thus, the gray code can be used as a code for an A/D converter or an input-output device. The gray code converter 470 is used to generate quadrature signals to minimize errors and exemplary embodiments of the present invention are not limited to its inclusion. Instead of the gray code converter 470, a driving signal converter (not shown) generating a driving signal for the motor using a current estimation state or a recent state can be included. The driving signal can also be generated by using a predetermined look-up table constructed using the current estimation state or the recent state.

FIG. 5 is a waveform diagram for explaining a process of generating quadrature signals in the spatial interpolator 230 of FIG. 2 when a first analog encoder signal 500 and a second analog encoder signal 510 is divided into 8 sections numbered 0 to 7.

Referring to FIG. 5, a method of estimating a subsequent state will now be described.

For example, when a current state is assumed to be at a position 501 for the first analog encoder signal 500 output from an analog encoder, a previous state is at a position 502, and a subsequent state is at a position 503. When a current state is assumed to be at a position 511 for the second analog encoder signal 510, a previous state is at a position 512, and a subsequent state is at a position 513.

When PCSI X_up of the first analog encoder signal 500 is determined, a value output from a first comparator (341 of FIG. 3) is “1” since the recent state 502 is greater than the current analog encoder position 501 when the analog encoder rotates in a forward direction. When PCSI Y_up of the second analog encoder signal 510 is determined, a value output from a second comparator (343 of FIG. 3) is also “1” since the recent state 512 is greater than the current analog encoder position 511. When the analog encoder rotates in the forward direction, a current estimation state is predicted as a state “4”. Similarly, when the analog encoder rotates in a backward direction, the current estimation state is predicted as a state “3” since both values of X_up and Y_up are all “0”.

In Table 2, undesirable cases exist when X_up or Y_up is “1” and the other is these cases, the current estimation state can be ignored.

TABLE 2

| X_up | Y_up | Current estimation state |
|---|---|---|
| 0 | 0 | 3 |
| 0 | 1 | X (Don't care) |
| 1 | 0 | X (Don't care) |
| 1 | 1 | 4 |

In the exemplary embodiment of the present invention, one period of an analog encoder signal output from the analog encoder is composed of 8 sections, such as, states numbered from 0 to 7, and each state is changed only to an adjacent state.

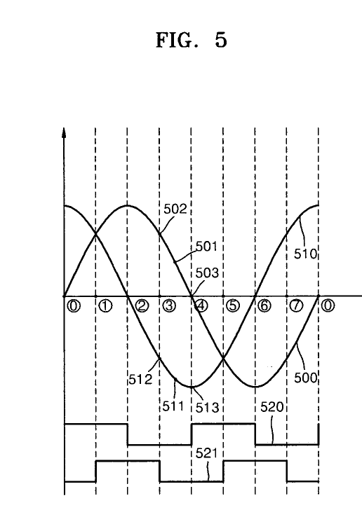

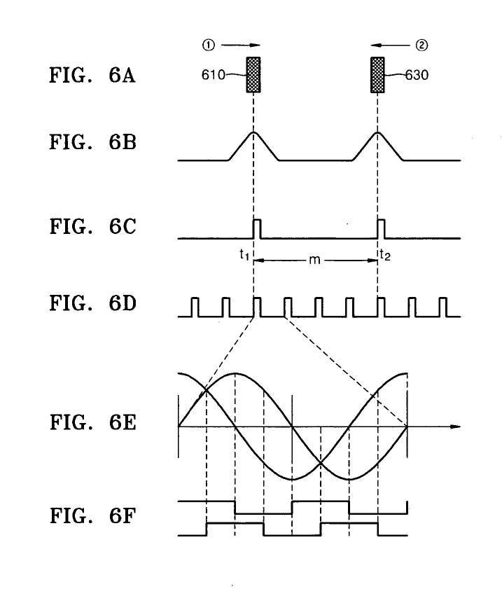

FIGS. 6A through 6F illustrate test marks used in a process of determining an image alignment error and related signal waveforms.

Referring to FIGS. 6A through 6F, FIG. 6A illustrates first and second test marks 610 and 630 used in an exemplary embodiment of the present invention. The first and second test marks 610 and 630 are set apart from each other by a designed distance. The designed distance is an arbitrary distance between the first and second test marks 610 and 630 when the first and second test marks 610 and 630 are printed, and is used to obtain an image alignment error of the image forming apparatus. The first and second test marks 610 and 630 can be printed on a printing medium using a different method, respectively. For example, when the first and second test marks 610 and 630 are for image alignment error compensation in a horizontal direction, one of the first and second test marks 610 and 630 is printed by moving a carriage from the left to the right (a direction (\textcircled{1})), and the other is printed by moving the carriage from the right to the left (a direction (\textcircled{2}). When the first and second test marks 610 and 630 are for image alignment error compensation in a vertical direction, one of the first and second test marks 610 and 630 is printed by moving the carriage downward, and the other is printed by moving the carriage upward. In another exemplary embodiment of the present invention, a monochrome cartridge is discriminated from a color cartridge. That is, one test mark is made using the monochrome cartridge, and the other test mark is made using the color cartridge. The two test marks printed in different directions have an actual distance different from the designed distance due to non-uniformity of cartridge movement, mechanical distortion, a delay in ink ejection, and the use of separate cartridges for different colors.

The exemplary embodiment of the present invention illustrates a case in which compensation exists for an image alignment error in the horizontal direction.

FIG. 6B illustrates a result obtained by detecting the first and second test marks 610 and 630 printed on the printing medium with the test mark detector 110.

FIG. 6C illustrates first and second detection signals output to the actual distance calculator 170 when the first and second test marks 610 and 630 are detected by the test mark detector 110. The actual distance between the first and second test marks 610 and 630 is m.

FIG. 6D illustrates encoder output pulses output from a digital encoder. FIG. 6E illustrates one period of analog encoder signals output from the analog encoder 210. FIG. 6F illustrates encoder output pulses composed of two periods of quadrature signals obtained by dividing each of the analog encoder signals illustrated in FIG. 6E into 8 sections. In this case, a resolution is two times that which is obtained with the digital encoder.

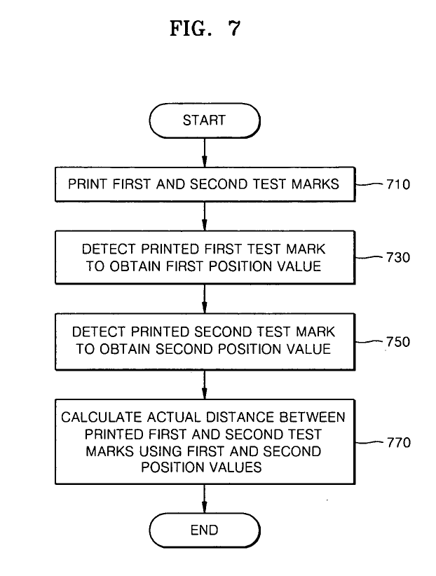

FIG. 7 is a flowchart of an image alignment method in an ink-jet image forming apparatus, according to an exemplary embodiment of the present invention. The method can be included in firmware of the image forming apparatus or programmed as a separate application program, which is stored in a controller (not shown) of the image forming apparatus.

Referring to FIG. 7, first and second test marks are printed on a printing medium with a designed distance apart from each other in operation 710.

In operation 730, the first test mark printed on the printing medium is detected. At this time, a first position value output from the spatial interpolator 230 through the analog encoder 210 is obtained.

In operation 750, the second test mark printed on the printing medium is detected. At this time, a second position value output from the spatial interpolator 230 through the analog encoder 210 is obtained.

In operation 770, an actual distance between the first and second test marks is calculated using the first and second position values.

According to another exemplary embodiment of the present invention, after operation 770, a difference between the designed distance and the actual distance can be obtained and the difference can be determined to be an image alignment error.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing exemplary embodiments of the present invention can be construed by programmers skilled in the art to which the present invention pertains.

As described above, according to exemplary embodiments of the present invention, position values are obtained by counting the pulses of quadrature signals obtained by spatially interpolating output signals of an analog encoder. An actual distance can be measured using first and second position values obtained when first and second test marks are detected. As a result, a user does not have to directly check the test marks for image alignment. This results in an increase in user convenience and a high resolution can be obtained even if an analog encoder with a reduced cost or reduced class is used, thereby improving the accuracy of image alignment error compensation.

While the present invention has been shown and described with reference to certain exemplary embodiments thereof, it will be understood by those of ordinary skill in the art that various changes in form and details may be made therein without departing from the spirit and scope of the present invention as defined by the following claims and their equivalents.

What is claimed is:

1. An image forming apparatus having an image alignment function comprising:
a test mark detector for detecting first and second test marks printed on a printing medium;
an encoder output pulse generator for generating encoder output pulses;
an absolute position determiner for determining absolute positions by counting the encoder output pulses output from the encoder output pulse generator; and
an actual distance calculator for receiving first and second position values output from the absolute position determiner when the first and second test marks are detected and calculating an actual distance between the first and second test marks using the first and second position values.

2. The apparatus of claim 1, wherein the first and second test marks are printed on the printing medium using different image printing methods.

3. The apparatus of claim 1, wherein the first and second test marks are printed in different image printing directions.

4. The apparatus of claim 1, further comprising an image alignment error determiner for obtaining a difference between the designed distance and the actual distance and for determining the difference as an image alignment error.

5. The apparatus of claim 1, wherein the encoder output pulse generator comprises:
an analog encoder for generating analog encoder signals; and
a spatial interpolator for sampling the analog encoder signals by dividing one period of each of the analog encoder signals into reference sections, generating encoder output pulses comprising a resolution increased relative to a physical resolution in proportion to the number of sections into which the analog encoder signals are divided, and outputting the generated encoder output pulses to the absolute position determiner.

6. The apparatus of claim 5, wherein when the number of sections comprises N (N comprises a positive integer), the resolution comprises N/4 times the resolution of a digital encoder corresponding to the analog encoder.

7. The apparatus of claim 5, wherein the spatial interpolator generates encoder output pulses as quadrature signals for controlling a motor by obtaining positional change state information (PCSI) obtained by comparing a recent state containing fine position information in one period of the analog encoder signals to the analog encoder signal output from the analog encoder, and predicting a current estimation state reflecting a current position of the analog encoder position from the PCSI.

8. The apparatus of claim 5, wherein the spatial interpolator comprises:
an analog encoder pattern storage unit for storing sampled analog encoder patterns generated from fedback analog encoder signals output from the analog encoder and outputting analog encoder pattern values corresponding to a recent state;
a comparing unit for generating PCSI by comparing the analog encoder pattern values to the analog encoder signals output from the analog encoder;
a recent state latch unit for setting a recent state by latching a current estimation state in response to a reference clock;
a current state determiner for determining a current estimation state based on the PCSI and the recent state; and
a driving signal generator for generating a motor driving signal using at least one of the current estimation state and the recent state.

9. The apparatus of claim 8, wherein the spatial interpolator further comprises a digital/analog (D/A) converting unit converting analog encoder pattern values output from the analog encoder pattern storage unit into a converted analog signal and outputting the converted analog signal to the comparing unit.

10. The apparatus of claim 8, wherein the spatial interpolator further comprises an analog encoder pattern generator generating the sampled analog encoder patterns by feeding back and sampling first and second analog encoder signals output from the analog encoder.

11. The apparatus of claim 8, wherein the driving signal generator generates quadrature signals by converting at least one of the current estimation state and the recent state into a gray code and outputs the quadrature signals as a driving signal.

12. The apparatus of claim 8, wherein the driving signal is generated using a look-up table indicating correspondences between at least one of the current estimation state and the recent state and the driving signal.

13. The apparatus of claim 9, wherein the D/A converting unit comprises first and second D/A converters for converting the digital pattern values corresponding to first and second analog encoder signals read from the analog encoder pattern storage unit into converted analog patterns and for outputting the converted analog patterns to the comparing unit.

14. The apparatus of claim 9, wherein the D/A converting unit comprises a D/A converter for converting one for each state of the digital pattern values according to first and second analog encoder signals read from the analog encoder pattern storage unit into a converted analog pattern according to valid channel information and for outputting the converted analog pattern to the comparing unit.

15. An image alignment method comprising:
printing first and second test marks separated by a designed distance on a printing medium;
detecting the printed first and second test marks from the printing medium;
obtaining first and second position values when the first and second test marks are detected; and
calculating an actual distance between the printed first and second test marks using the first and second position values.

16. The method of claim 15, wherein the first and second test marks are printed on the printing medium using different image printing methods.

17. The method of claim 15, wherein the first and second test marks are printed in different image printing directions.

18. The method of claim 15, wherein the obtaining of the first and second position values comprises:
generating analog encoder signals in an analog encoder;
generating a motor driving signal by sampling one period of the analog encoder signal a reference number of times to divide each of the analog encoder signal into a reference number of sections, the motor signal comprising a resolution increased relative to the resolution of the analog encoder signal in proportion to the reference number of sections;
outputting a position value by counting pulses of the motor driving signal; and
obtaining the first and second position values when the first and second test marks are detected.

19. The method of claim 18, wherein the generating of the motor driving signal comprises:
sampling in each section an analog encoder pattern from the analog encoder signals output from the analog encoder during initialization;
determining a recent state and a current estimation state by comparing the analog encoder pattern to the analog encoder signal; and
generating quadrature signals from the recent state and the current estimation state and outputting the quadrature signals as the motor driving signal.

20. The method of claim 19, wherein the quadrature signals are obtained by obtaining positional change state information (PCSI) obtained by comparing a recent state containing fine position information in one period of the analog encoder signals to the analog encoder signal output from the analog encoder, and predicting a current estimation state reflecting a current position of the analog encoder position from the PCSI.

21. The method of claim 19, wherein the determining of the recent state and the current estimation state comprises:
converting the analog encoder pattern into a converted analog signal;
generating PCSI by comparing the converted analog signal to the analog encoder signal output from the analog encoder; and
determining a current estimation state, which comprises a subsequent state, based on the PCSI and a recent state of the analog encoder.

22. The method of claim 19, wherein the quadrature signals are generated by referring to a look-up table using the recent state and the current estimation state.

23. The method of claim 19, wherein the quadrature signals are generated from a state information code containing information regarding the quadrature signals.

24. The method of claim 18, wherein, when the number of sections comprises N (N comprises a positive integer), the resolution comprises N/4 times the resolution of a digital encoder corresponding to the analog encoder.

25. The method of claim 15, further comprising: obtaining a difference between the designed distance and the actual distance and determining the difference to be an image alignment error.

26. A computer readable recording medium comprising a computer readable program recorded thereon for performing at least one of the printing, detecting, obtaining, and calculating of claim 15.
